(19) United States
(12) Patent Application Publication
(10) Pub. No.: US 2013/0323591 A1
(43) Pub. Date: Dec. 5, 2013

(54) Accumulator Cell with Coated Terminal

(71) Applicants: Thomas Woehrle, Stuttgart-Feuerbach (DE); Joachim Fetzer, Bad-Ditzenbach (DE); Stephan Leuthner, Leonberg (DE); Holger Fink, Stuttgart (DE)

(72) Inventors: Thomas Woehrle, Stuttgart-Feuerbach (DE); Joachim Fetzer, Bad-Ditzenbach (DE); Stephan Leuthner, Leonberg (DE); Holger Fink, Stuttgart (DE)

(73) Assignees: Samsung SDI Co. Ltd, Yongin-si Gyeonggi-do (KR); Roberet Bosch GmbH, Stuttgart (DE)

(21) Appl. No.: 13/990,439

(22) PCT Filed: Nov. 21, 2011
(86) PCT No.: PCT/EP2011/070545

§ 371 Date: Aug. 16, 2013

(30) Foreign Application Priority Data
Nov. 30, 2010 (DE) 102010062183.8

(51) Int. Cl. H01M 2/30

(52) U.S. Cl. CPC H01M 2/30
USPC 429/211

(57) ABSTRACT

An accumulator cell comprises two terminals. One terminal is provided with a coating made of a metal. The metal is identical to the metal of which the second terminal consists, or each terminal is coated with a coating made of the same metal. The disclosure further relates to an accumulator and a motor vehicle with an accumulator.

The present invention relates to an accumulator cell with two terminals, to an accumulator having at least two accumulator cells, and to a motor vehicle having an electric drive motor for driving the motor vehicle and having an accumulator which is connected or can be connected to the electric drive motor.

### PRIOR ART

Lithium-ion cells have at least a positive and a negative electrode (cathode and, respectively, anode), which can reversibly incorporate (intercalation) or again release (deintercalation) lithium ions (Li+). The terms lithium-ion cell, lithium-ion polymer cell, lithium-ion cell battery, accumulator and system are used largely synonymously.

Stringent requirements are placed on lithium-ion accumulators, in particular in the automotive sector in respect of the gravimetric energy density (indicated in Wh/kg) in order to achieve, for example, the highest possible ranges for vehicles which are driven by electric motors. The rated capacitance of a lithium-ion cell is determined by the so-called active materials. However, so-called passive materials or “dead materials” are also present in every lithium-ion cell, these therefore having an influence on the energy density of the lithium-ion cell. Said passive materials include, for example, electrical conductive material, electrode binders, separators, output conductor sheets, collectors, terminals and the housing of the cell and of the accumulator itself.

Terminals are used to ensure the flow of current out of and into the lithium-ion cell.

The construction of a lithium-ion cell with output conductors, collectors and the external terminals is described, by way of example, in US 20080107961A1.

Aluminum-based terminals are usually used for the positive electrode side in lithium-ion cells. Copper, nickel or nickel-plated copper are used on the negative electrode side since the use of aluminum on the negative side would otherwise result in lithium and aluminum being alloyed on account of the provided potential.

Since the two terminals of a lithium-ion cell are composed of different materials, metal combinations which can lead to difficulties during processing are produced when assembling the lithium-ion cells to form relatively large units. Therefore, it is possible to connect, for example, aluminum to copper or aluminum to stainless steel by welding only with great difficulty. In addition, connections come loose during operation, in the case of routine mechanical loading, for example oscillation, with the result that the entire lithium-ion system breaks down.

Accumulator cells which have a terminal which is surface-treated with gold and/or a terminal which is surface-treated with nickel are known from US 2006/0292442 A1. Surface-treatment is performed in order to improve the conductivity and the corrosion resistance of the terminal.

### DISCLOSURE OF THE INVENTION

The invention provides an accumulator cell, preferably a lithium-ion cell, which has a conventional structure with two terminals, wherein one terminal is provided with a coating which is composed of a metal which is identical to the metal from which the second terminal is composed. As an alternative, both terminals can also each be provided with a coating of the same metal.

The cell according to the invention offers the advantage that the disadvantages which occur in the case of said prior art when assembling or establishing contact between the terminals can be avoided. In addition, savings in weight, which increase the energy density of the accumulator cells, can be achieved given a corresponding combination of the various metals when manufacturing the terminals.

The coating of the terminal or of the terminals is preferably composed of copper, nickel, stainless steel or aluminum.

It goes without saying that other metals such as gold, silver and the like are also a priori suitable, but these are not preferred for reasons of cost.

An additional subject matter of the invention is an accumulator having at least two accumulator cells, wherein contact-connection is made with the terminals of the at least two accumulator cells for forming the accumulator by the metal which is used for the coating, with the result that a sufficient degree of stability in relation to mechanical loading is advantageously ensured.

A motor vehicle having an electric drive motor for driving the motor vehicle and having an accumulator which is connected or can be connected to the electric drive motor and has accumulator cells according to the invention is likewise claimed.

The coating of the terminal completely surrounds said terminal, wherein, on the one hand, a thickness of the coating which is as low as possible is preferred but, on the other hand, a certain minimum thickness is required in order that no defects are created in the coating during welding or soldering when combining the various terminals.

The coated terminal can, for example, have an aluminum core with a diameter of 4970 μm to which a coating of 15 μm of copper is applied, this resulting in an overall diameter of likewise 5000 μm.

In a second exemplary embodiment, the coated terminal has a diameter of 4000 μm in total, wherein the core is composed of aluminum to which a coating with a 5 μm thickness of stainless steel is applied.

Possible combinations of the various metals when assembling the accumulator cell according to the invention are given in Tables 1 and 2:

TABLE 1

| Metallic base material | | Metal connector which |
|---|---|---|
| of the terminal | Coating | connects cells and terminals |
| Aluminum | Copper | Copper |
| (positive terminal) | | |
| Copper | (None) | Copper |
| (negative terminal) | | |

TABLE 2

| Metallic base material | | Metal connector which |
|---|---|---|
| of the terminal | Coating | connects cells and terminals |
| Aluminum | Stainless steel | Stainless steel |
| (positive terminal) | | |
| Copper | Stainless steel | Stainless steel |
| (negative terminal) | | |

Different dimensions of the terminals, the coating and the coated terminals and other combinations of metals are possible within the scope of the invention.

The corresponding terminal or the terminals for the accumulator cell according to the invention are manufactured by the application of a thin metal layer to a conventional terminal or a terminal with an adapted diameter.

The coating is preferably applied either

a) by electroplating,

b) by means of sputtering, or

c) by means of ion beam coating.

In all the methods, it is necessary to ensure that the applied layer does not have any defects.

Particularly good results are achieved with lithium-ion cells with terminals which have been coated by means of ion beam coating.

Assembled lithium-ion cells according to the invention with said terminals exhibit the same electrical performance (such as, for example, internal resistance) and identical behavior in the case of long-term cyclization and storage as a lithium-ion reference system with conventional terminals. For example, it was a priori not possible to rule out removal of the metal coating from the terminal during storage or operation of the assembled lithium-ion system, which would have had a very negative influence on the electrochemical performance.

It was surprisingly found, especially in mechanical tests (for example vibration tests), that lithium-ion systems according to the invention with coated terminals perform better than the reference system; for example, the internal resistance in the system according to the invention after mechanical tests did not rise as much as in the conventional reference system.

Advantageous developments of the invention are specified in the dependent claims and described in the description.

### DRAWINGS

Exemplary embodiments of the invention will be explained in greater detail with reference to the following description and drawings, in which:

FIG. 1 shows a perspective view of a terminal of an accumulator cell according to the invention with a customary spatial configuration according to the prior art (US 20080107961 A1), and

FIG. 2 schematically shows assembly of accumulator cells according to the invention.

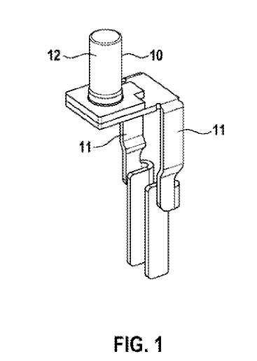

FIG. 1 discloses a terminal 10 for an accumulator cell (not illustrated) according to the invention which is connected to a collector 11. The entire terminal 10 is provided with a coating 12 which is composed of a metal which is used as a connector when assembling accumulator cells to form relatively large units.

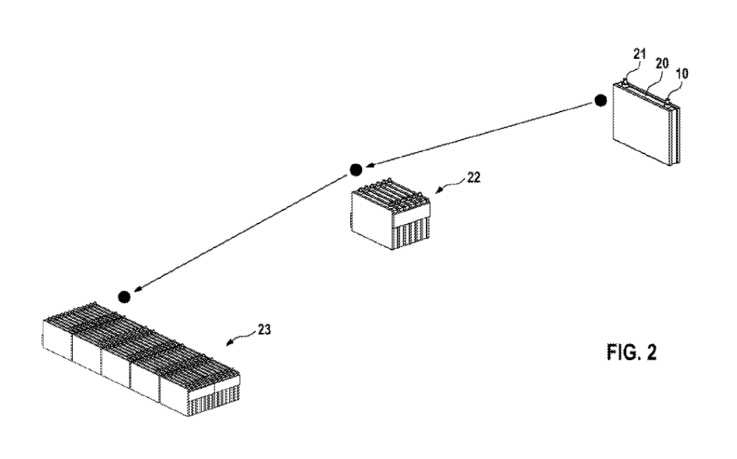

FIG. 2 shows the assembly of accumulator cells 20 according to the invention with two terminals 10 and 21, wherein one terminal 10 or else both terminals 10, 21 is/are, according to the invention, provided with a coating 12. A plurality of accumulator cells 20 can be combined to form an accumulator module 22, and accumulator modules can be combined to form an accumulator pack 23, wherein corresponding contact is made with the terminals 10 and 21 in each case.

1. An accumulator cell comprising:
a first terminal; and
a second terminal composed of a metal,
wherein the first terminal has a coating which is composed of the metal identical to the metal from which the second terminal is composed.

2. The accumulator cell as claimed in claim 1, wherein the accumulator cell is a lithium-ion cell.

3. The accumulator cell as claimed in claim 1, wherein the metal of the coating is selected from the group consisting of copper, nickel, stainless steel, and aluminum.

4. The accumulator cell as claimed in claim 1, wherein the coating is applied by electroplating.

5. The accumulator cell as claimed in claim 1, wherein the coating is applied by means of sputtering.

6. The accumulator cell as claimed in claim 1, wherein the coating is applied by means of ion beam coating.

7. An accumulator comprising:
a first accumulator cell having (i) a first terminal and (ii) a second terminal composed of a metal, wherein the first terminal has a coating composed of the metal identical to the metal from which the second terminal is composed; and
a second accumulator cell having (i) a third terminal and (ii) a fourth terminal composed of the metal, wherein the third terminal has the coating which is composed of the metal,
wherein the metal used for the coating makes contact is with the terminals of the first and second accumulator cells to form the accumulator.

8. A motor vehicle having an electric drive motor for driving the motor vehicle and having an accumulator as claimed in claim 7 connected to the electric drive motor.

9. An accumulator cell comprising:
a first terminal having a first coating; and
a second terminal having a second coating,
wherein the first coating and the second coating are composed of an identical metal.
